(19) United States
(12) Patent Application Publication
(10) Pub. No.: US 2005/0029687 A1
(43) Pub. Date: Feb. 10, 2005

(54) Method for manufacturing magnetic recording medium substrates

(76) Inventors: Masatoshi Ishii, Takefu-shi (JP); Toshihiro Tsumori, Takefu-shi (JP); Ken Ohashi, Takefu-shi (JP)

Correspondence Address: MYERS BIGEL SIBLEY & SAJOVEC, PO BOX 37428, RALEIGH, NC, 27627, US

(21) Appl. No.: 10/889,474

(22) Filed: Jul. 12, 2004

(30) Foreign Application Priority Data
Jul. 15, 2003 (JP) 2003-197120

(51) Int. Cl. B29D 17/00

(52) U.S. Cl. 264/1.33

(57) ABSTRACT

Provided is a highly efficient method for manufacturing preferably a small diameter substrate for a magnetic recording medium. More specifically, provided is a method for manufacturing a substrate for a magnetic recording medium, comprising a step of coring for obtaining a plurality of doughnut-shaped substrates having a diameter at most 65 mm from a monocrystalline silicon wafer having a diameter at least 150 mm and at most 300 mm, wherein coring of an inner diameter and an outer diameter are carried out by different means. In said step of coring said coring of the inner diameter is preferably carried out by water jet cutting or laser cutting.

### BACKGROUND OF THE INVENTION

1. Field of the Invention

The invention relates to a substrate for a magnetic recording medium, a small diameter substrate having an inner diameter preferably of not more than 20 mm, more preferably of not more than 12 mm.

2. Description of the Related Art

The increase in recording density (surface density) of magnetic recording has been extremely rapid, the rapid increase over these past 10 years advancing continuously at yearly rates of 50 to 200%. At the mass production level, products with 70 Gbits/inch² are shipped, while surface recording densities more than twice higher, namely 160 Gbits/inch², have been reported at the laboratory level. Surface recording densities at the mass production level correspond to 80 Gbytes per one platter of a 3.5″ HDD (3.5 inch), and corresponds to 40 Gbytes per single platter of a 2.5″ HDD. At these recording volumes, installation of single platter recording media gives a sufficient volume for use in an ordinary desk top personal computer (equipped with a 3.5″ HDD) or a laptop personal computer (equipped with a 2.5″ HDD).

It is expected that recording densities will also continue to improve in the future. However, conventional horizontal magnetic recording methods are approaching their thermal fluctuation recording limit. Thus, when recording densities of 100 Gbit/inch² to 200 Gbit/inch² are reached, it is believed that it will be replaced by perpendicular magnetic recording. At the present time it is not certain what the recording limit of perpendicular magnetic recording will be, but it is believed that 1000 Gbit/inch² (1 Tbit/inch²) is achievable. If these types of high recording densities are achieved, it will be possible to obtain a recording volume of 600 to 700 Gbytes per single platter of a 2.5″ HDD.

As it is very likely that such a large volume will not be fully utilized by ordinary personal computer use, recording media having a diameter smaller than 2.5″ are gradually coming into use. Typically, there are substrates of 1.8″ or 1″, and 1.3″ HDDs was also sold in the past. HDDs of not more than 2″ have very small capacities at the present time, however if magnetic recording densities increase in the future, then a 1.8″ HDD in a personal computer (particularly in a laptop) can ensure a sufficient recording volume. Furthermore, the recording volume of a 1″ HDD is in the order of 1 to 4 Gbyte at the present, however if the volume was several times larger, many possibilities for a wide range of mobile uses would emerge, not limited just to digital cameras and the like, but also for personal computers and digital video cameras, information terminals, hand held music devices and mobile phones for example. Small diameter HDDs, small diameter recording media and substrates having diameter of not more than 2″ offer promising applications in the future.

As a substrate for the recording medium of a HDD, Al alloy substrates are mainly used for 3.5″ substrates, while glass substrates are mainly used for 2.5″ HDDs. There is a high possibility of HDDs in mobile applications, such as in laptop computers, receiving a shock. Because the possibility of data loss from scratches to the recording medium or the head resulting from head collision is large, the 2.5″ HDDs mounted in these devices have come to use very hard glass substrates. Consequently, there is also a large possibility that glass substrates will also be used in small diameter substrates of not more than 2″.

However, because small diameter substrates of not greater than 2″ are mainly used in mobile applications, shock resistance is of greater importance than for 2.5″ substrates mounted in laptop computers. Furthermore, from the need for the smaller size, there is a demand for making all parts including the substrate smaller and thinner. A thickness of the 2″ substrate board is demanded that is even thinner than the 0.635 mm standard thickness of the 2.5″ substrate. Due to the specifications required of such small diameter substrates, the demand is for substrates which are easily fabricated, which have a high Young's modulus and which have sufficient strength even though thin. Glass substrates have a number of problems on these points.

First, when the board thickness of the crystalline glass substrate which is actually used is not more than 0.635 mm, the Young's modulus is insufficient and resonance frequencies exist in the practical rotating region during rotation. Consequently, it is difficult to slim down further than this. Furthermore, although glass base plates are already used as substrates with a thickness in the 0.8 mm range, it is difficult to fabricate glass compositions which are any thinner than this, as demanded as HDD base plates. Because of this, it is necessary to adjust the thickness by lap-polishing from the 0.8 mm range down to the 0.5 mm range or even thinner. This is not preferable as it increases process costs and process time because the polishing time for width adjustment becomes very long.

Furthermore, the glass substrate is naturally a non-conductor, so there is the problem of charge up on the substrate when making films by sputtering. Thus, it is necessary to insert a metal film buffer between the substrate and the magnetic film in order to ensure favorable contact with the magnetic film. Basically, these technical problems have been solved, however this is one reason why it is difficult to use glass substrates in a sputter film forming process. Because of this, it would be ideal if it were possible to confer conductivity to the substrate, however this is difficult with glass substrates.

Just as glass substrates are mainly used even in 2.5″ HDDs, Al alloy substrates are completely unsuitable for mobile applications. It was stated previously that the hardness of the substrate is insufficient. Because substrate stiffness is also insufficient, the only way to ensure that resonance frequencies are above the actual rotating region is to increase the thickness. Thus, it is not possible to consider it as a candidate substrate for mobile applications.

A number of other substitute substrates have been proposed, such as sapphire glass, SiC substrates, engineering plastic substrates, carbon substrates and the like, however from the standard evaluations of strength, processability, cost, surface smoothness and compatibility for film deposition and the like, all are inadequate as substitute substrates for small diameter substrates.

Use of a Si monocrystalline substrate has been proposed as a HDD recording film substrate (Japanese Patent Provisional Publication No.6-176339/1994). A Si monocrystalline substrate is superior as the HDD substrate because of its excellent substrate smoothness, environmental stability and reliability, and because its stiffness is also comparatively high when compared to a glass substrates. Differing from a glass substrate, it has at least the conductivity of a semi-conductor. Furthermore, because it is generally the case that a regular wafer includes P-type or N-type dopant, the conductivity is even higher. Consequently, there is no problem with charge-up during sputter film formation as with glass substrates, and it is possible to sputter a metal film directly onto the Si substrate. Furthermore, because it has favorable thermal conductivity, the substrate is easily heated, film formation is possible even at high temperatures above 300° C. and it is excellently suited to the sputter film forming process. Si monocrystalline substrates for semi-conductor IC use are mass-produced as wafers having a diameter of 100 mm to 300 mm.

### SUMMARY OF THE INVENTION

However, it is presently difficult to obtain small diameter wafers having a diameter of at most 100 mm. Consequently, it is more realistic to cut out the desired small diameter substrate by coring from 6″ to 8″ wafers which are presently in common use. Because the price of silicon monocrystalline wafers is not low, it is important that as many HDD substrates are cut out from a single wafer as possible. The coring for a diameter having not more than 20 mm in accordance with only conventional coring with a cup grinder requires the slow rotational speed for the slow processing speed. Even if the processing speed is slowed down, chipping increases so that the wafer breakage rate increases.

According to the invention, regarding manufacturing methods of non-magnetic substrates, it is an object to provide a high efficiency method for manufacturing a small diameter substrate for a magnetic recording medium having an inner diameter preferably of not more than 20 mm, more preferably of not more than 12 mm.

With regards to manufacturing methods of non-magnetic substrates, particularly relating to small diameter substrates having an inner diameter of at most 20 mm, as a result of repeated keen investigations into inner and outer diameter coring methods, the inventors have found that it is possible to manufacture at high efficiency a plurality of the substrates from a single monocrystalline silicon wafer with corings of inner diameter and outer diameter by different cutting methods. Particularly, the inventors have found that it is effective that the coring of the inner diameter is carried out by water jet cutting or laser cutting.

That is, according to the invention, a method for manufacturing a substrate for a magnetic recording medium, the method comprising a step of coring for obtaining a plurality of doughnut-shaped substrates having an outside diameter of not more than 65 mm and a preferable inside diameter of not more than 20 mm from a monocrystalline silicon wafer having a diameter of at least 150 mm and not more than 300 mm, wherein corings of an inner diameter and an outer diameter are carried out by different cutting means. It may be preferable that the coring of inner diameter is carried out by a water jet cutting or a laser cutting.

According to the invention, high efficiency production of substrates can be attained by obtaining a plurality of substrates from a single monocrystalline silicon wafer with corings of the outer diameter and inner diameter by different cutting means.

### BRIEF DESCRIPTION OF THE DRAWINGS

FIG. 1 is a process overview showing an example of fabricating a substrate for a HDD magnetic recording medium, using a silicon monocrystalline wafer as a base plate.

### DETAILED DESCRIPTION OF THE PREFERRED EMBODIMENTS

A monocrystalline silicon wafer 2 having a diameter of 200 mm is obtained by slicing a monocrystalline silicon rod. Subsequently, a plurality of doughnut-shaped substrates 3 having an outer diameter of not more than 65 mm and an inner diameter of not more than 20 mm are obtained in a step of coring. It may be preferably subjected to a step of chamfering of the inner and outer circumferential faces of the doughnut-shaped substrates 3 and a step of the inner and outer circumferential face-polishing. A subsequent step of alkali etching, a step of polishing (or grinding) both surfaces and a step of washing are usually carried out.

A step of lapping for removing preferably 10 μm to 100 μm from the surface of the monocrystalline silicon wafer or the doughnut-shaped substrate may be comprised preferably before or after the step of coring, for example, before the step of coring, between the step of coring and the step of chamfering, between the step of chamfering and the step of circumferential face-polishing, or after the step of circumferential face-polishing. The step of lapping may be more preferably comprised, before the step of coring, between the step of chamfering and the step of circumferential face-polishing, or after the step of circumferential face-polishing.

The monocrystalline silicon wafer used in the step of coring may preferably have a plane orientation of (100), a diameter of at least 150 mm and not more than 300 mm and a thickness of 0.4 to 1 mm.

Semiconductor grade silicon monocrystalline wafers are expensive. Even if a 65 mm diameter substrate is fabricated using the monocrystalline base plate, it will cost from a few times to ten times the cost of a glass substrate. No matter how better the characteristic properties of the silicon monocrystalline substrate are, just this cost difference alone makes it difficult to put these to practical use.

In the step of coring, coring of seven 2.5″ HDD substrates from an 8″ wafer can be performed using the method proposed in Japanese Patent Provisional Publication No. 10-334461/1998. In this case, by setting the process machining allowance during coring of the 2.5″ substrates so that the allowance is overlapped between adjacent cored substrates, coring of a maximum of seven 2.5″ substrates from the 8″ wafer can be performed.

When the inner diameter is not more than 20 mm, it may be more efficient that coring of an inner diameter side (inner diameter coring or inner circumference coring) is carried out at first, and then using the inner diameter core portion as a hold-down hole, an outer diameter side (outer diameter coring or outer circumferential coring) is carried out by a different cutting method. As described previously, the circumferential speed of the cup grinder for inner diameter coring is slow so that the wafers are easily chipped. Furthermore, because the wafer breakage rate is also high, there is a large amount of waste if the same cutting method is carried out. If the cores which have undergone the inner diameter coring are inspected, and only if the cores which pass the inspection are subjected to the outer diameter coring process, then the production efficiencies may be enhanced.

In a conventional cup grinding method, productivity of the inner diameter side coring process may not be high. The efficiency can be raised preferably by use of the water jet cutting method or the laser cutting method. It is possible to reduce the time of the inner diameter coring in this way, and chipping may be also lessened. Even more preferably, if the inner diameter side coring is carried out by the laser cutting method, chipping may be greatly reduced and yield may be improved. The effect is particularly pronounced when the inner diameter is not more than 20 mm.

In the laser method, when a CO₂ laser is used as the light source, the power density is comparatively low with respect to the total power. Accordingly, heat may be easily transferred to the coring substrate or the leftover wafer, and there is a tendency to fracture because of heat shock. High power density solid-state lasers (for example YAG lasers) are preferred because thermal loss to surrounding members is low and the laser power is actually utilized in coring itself. According to the laser cutting method, although the reason is not clear, the outer diameter cutting takes disproportionately longer than the inner diameter cutting. Consequently, there may be a reduction in yield as wafers may be destroyed by the effects of thermal distribution.

The water jet cutting method is a method in which an abrasive material such as garnet particles having a mean particle diameter of 20 to 200 μm is mixed into high pressure water of at least 100 MPa and jetted. The water jet cutting method is advantageous because standoff distance (processing width) is short, a high pressure on the substrate is not generated and a thermal effect is substantially absent.

According to the water jet cutting method, because cutting the external circumference occurs after piercing (opening a preparatory hole), the doughnut-shaped annular substrates may become liable to be damaged and may become an annular substrate with poor roundness.

The outer circumferential coring may be carried out in a different cutting method, for example by conventional coring such as the cup grinder, electric discharge, water jet cutting or a laser cutting. However, the outer coring method is different from the inner coring method.

Although it does not matter whether it is before or after the step of coring, it may be preferable to provide a step of lapping for polishing off preferably 10 μm to 100 μm from a wafer surface. When the step of lapping is provided after the step of coring, it may be provided, for example, between the step of coring and the step of chamfering, between the step of chamfering and the step of circumferential face-polishing, or after the step of circumferential face-polishing. The step of lapping may be preferably provided between the step of chamfering and the step of circumferential face-polishing, or after the step of circumferential face-polishing.

In the step of lapping, warping or swelling of the wafer base plate or the doughnut-shaped annular substrate may be inhibited and the thickness may controlled for the purpose of determining an appropriate amount to be polished in subsequent steps.

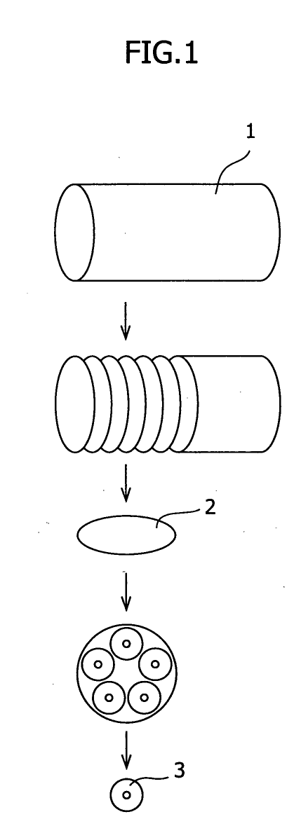

In the fabrication of the HDD substrate shown in FIG. 1, it may be also possible to provide a step of chamfering of the inner and the outer circumferential faces and a step of circumferential face-polishing after the step of coring of the base plate such as wafer.

The angle and dimensions of chamfering may be for the most part restricted as standard dimensions. Usually, the substrate can become a finished product through the step of chamfering. However, grinding particles and process waste which adheres to the edge or circumferential face may act to cause a reduction in substrate strength or may become a starting point for substrate rupture. Hence, it may be preferably subjected to the step of circumferential face-polishing after the step of chamfering, and then to the step of etching for removing the distorted layer. The circumferential face means the inner circumferential lateral surface and/or the outer circumferential lateral surface of the doughnut-shaped substrate.

After the step of circumferential face-polishing, or after the step of lapping after the step of circumferential face-polishing, it may be preferable that the substrate undergoes further steps including a step of alkali etching, a step of polishing the upper and lower surfaces of the substrate that has been alkali-etched, and a subsequent step of washing.

The step of alkali-etching for removing the process distortion from the step of lapping or the step of circumferential face-polishing, may be carried out, for example, by dipping in a 2 to 60 weight % solution of sodium hydroxide which is at 40 to 60° C.

The step of polishing the upper and lower surfaces of the alkali-etched substrate can be carried out in any of the methods known in the art. For example, it may be possible to clasp a substrate mounted in a carrier between an upper plate and a lower plate, and while rotating the substrate, to polish the substrate with colloidal silica as the grinding particles.

The step of washing can be carried out in any of the methods known in the art such as brush washing or chemical washing with an alkali and/or an acid solution.

The substrate for a magnetic recording medium of the invention can be treated in the same way as a conventional substrate. Introduction of a soft magnetic layer and a recording layer for example can produce a perpendicular magnetic recording medium. To increase close contact with the soft magnetic layer, it may be also possible to provide a primer layer in advance prior to forming the soft magnetic layer.

It may be also possible to provide a protective layer and a lubricating layer above the recording layer.

The invention will be explained based on examples below, however the invention is not limited to them.

An overview of examples is given below.

A large diameter monocrystalline silicon rod 1 is sliced so that a wafer 2 is formed. The wafer 2 is lapped with abrasive particles to even out its thickness and surface. Next, coring of the inner diameter side by water jet cutting or laser cutting is carried out. Then, coring of the outer diameter side is carried out by cup grinding processing so that the doughnut-shaped annular substrates 3 are cut out of the wafer. A plurality of substrates are thus produced due to the above. Next, the edges of the inner and the outer circumferential faces of the substrate are removed by grindstone. Subsequently, the front and rear surfaces of the substrate are polished so that the desired substrate is obtained. Next, grinding agents adhering to the substrate are removed in the step of washing so that production of the substrate is completed.

### EXAMPLE 1

A 200 mm diameter wafer 2 was obtained from a large diameter monocrystalline silicon rod 1, and lapped. Thirty six doughnut-shaped annular substrates 3 were obtained, wherein the 7 mm inner diameter side coring was carried out by water jet cutting using garnet particles #220 and the 26 mm outer diameter coring was carried out with a cup grander. Subsequently, coring required 271 minutes to process five wafers 2 and as a result 173 substrates 3 were obtained. However, outer diameter coring was not carried out on the 7 places which had been chipped during inner diameter coring.

### EXAMPLE 2

Apart from carrying out inner side coring with YAG laser cutting apparatus (YAG laser), processing was carried out in the same manner as in Example 1, in which five wafers 2 were processed in 285 minutes and as a result 180 substrates 3 were obtained without chipping.

### Comparative Example 1

Apart from carrying out both the inner and outer diameter corings by a cup grinder, processing was carried out the same way as in Example 1. Five wafers 2 were processed in 436 minutes and as a result, 112 substrates 3 were obtained. However, one wafer 3 broke during inner diameter coring, and outer diameter coring was not carried out on the 32 other places which had been chipped.

### Comparative Example 2

Apart from carrying out both the inner and outer diameter corings by water jet cutting, processing was carried out in the same way as in Example 1. Five wafers 2 were processed in 51 minutes and 129 substrates 3 were obtained. However, one wafer 3 broke during inner diameter coring, and outer diameter coring was not carried out on the 15 other places which had been chipped.

### Comparative Example 3

Apart from carrying out both the inner and outer diameter corings by YAG laser cutting, processing was carried out in the same way as in Example 1. Five wafers 2 were processed without chipping and 144 substrates 3 were obtained in 80 minutes. One wafer was broken during outer diameter coring.

As given above, when a cup grinder is used, the wafers are liable to be broken during inner coring. When water jet cutting or YAG laser cutting is used, the wafers are liable to be broken during outer coring. When the inner and outer diameter corings are carried out in different methods, the higher yield is obtained.

### EXAMPLE 3

Apart from setting the inner diameter to be 12 mm and the outer diameter to be 48 mm, processing was carried out in the same manner as in Example 1. Fifty one substrates 3 were obtained from five wafers 2 in 122 minutes. However, outer diameter processing was not carried out on the 4 places which had been chipped.

### EXAMPLE 4

Apart from setting the inner diameter to be 12 mm and the outer diameter to be 48 mm, processing was carried out in the same manner as in Example 2. Five wafers 2 were processed in 129 minutes and as a result 55 substrates 3 were obtained without chipping.

### Comparative Example 4

Apart from carrying out both inner diameter and outer diameter corings with a cup grinder and setting the inner diameter to be 12 mm and the outer diameter to be 48 mm, processing was carried out in the same manner as in Example 1. Five wafers 2 were processed in 218 minutes and as a result 43 substrates 3 were obtained. However, outer coring was not carried out on the 12 places which had been chipped.

1. A method for manufacturing a substrate for a magnetic recording medium, the method comprising:
a step of coring for obtaining a plurality of doughnut-shaped substrates having an outer diameter of at most 65 mm from a monocrystalline silicon wafer having a diameter of at least 150 mm and at most 300 mm
wherein the corings of an inner diameter and the outer diameter are carried out by different means.

2. The method for manufacturing a magnetic recording medium substrate according to claim 1,
wherein in said step of coring said coring of the inner diameter is carried out such that the inner diameter is at most 20 mm.

3. The method for manufacturing a magnetic recording medium substrate according to claim 1,
wherein in said step of coring said coring of the inner diameter is carried out by water jet cutting or laser cutting.

4. The method for manufacturing a magnetic recording medium substrate according to claim 2,
wherein in said step of coring said coring of the inner diameter is carried out by water jet cutting or laser cutting.
